(19) United States
(12) Patent Application Publication
(10) Pub. No.: US 2025/0083468 A1
(43) Pub. Date: Mar. 13, 2025

(54) WINDOWS NOTE CLIP

(71) Applicant: John Joseph Bleiman, Merced, CA (US)

(72) Inventor: John Joseph Bleiman, Merced, CA (US)

(21) Appl. No.: 18/445,506

(22) Filed: Sep. 11, 2023

(51) Int. Cl. B42F 1/12

(52) U.S. Cl. CPC B42F 1/12

(57) ABSTRACT

The Windows Note Clip is a paperclip fabricated from cardstock (or plastic) rather than from wire to hold note papers. This tool relies on the mathematical framework of 2 open diagonal windows that grip the note papers (or the index cards). The same mathematics that clip the notes together also carry the notes to be transported in a 3-ring binder for the research student or in a 3-ring conference notebook for the research writer. Hence, the paperclip is mobile to accompany the researcher to the library or to a seminar. As a recap, the camouflaged mathematical combination (as a number and a union) of the Windows Note Clip are: the 1/16″ extra width on all 4 sides of the 3″×5″ and the 4″×6″ note papers (or index cards), the ¼″ width of the end (the foot) of the window, the opposite position of the windows to provide the tension against the note papers, the necessity that the ¼″ end of the window rests exactly on the blue note frame to ensure that the note papers are level with the note frame, that the long diagonal frames of the open windows function as unseen satchel straps to hold (as a clip) the note papers, and the extra feature that the windows not only clip but also carry the note papers via the tension of the window frames.

### CROSS-REFERENCE TO RELATED APPLICATIONS

Not Applicable;

### STATEMENT OF FEDERALLY FUNDED RESEARCH OR DEVELOPMENT

Not Applicable;

### NAMES OF OTHER RESEARCHERS

Not Applicable;

### RESEARCH AGREEMENT

Not Applicable;

### REFERENCE TO SEQUENCE LISTING, TABLE, OR APPENDIX ON DISC

Not Applicable;

### STATEMENT OF PRIOR DISCLOSURE

Not Applicable.

### BACKGROUND OF THE INVENTION

A wire bending machine unintentionally gave birth in 1897 to a wire, double loop (a smaller loop inside a larger loop) clip that became known as the Gem Clip. The Windows Note Clip is an alternative paperclip that does not rely on wire, a pin, a staple, or a spring.

The Windows Note Clip fabricated from cardstock paper (or plastic) relies on 2 open diagonal windows that are opposite to each other that are the framework (the braces) of the clip that holds the note papers (or index cards).

A paraphrase about the composition of the Windows Note Clip is that the paper window frames on the paper paperclip become 1) a new concept since the diagonal, double frames arise as a natural progeny from the paper itself and also become 2) a required arrangement of the diagonal, paper double frames to be apart and opposite to each other as 2 windows to function as a paper paperclip.

The Windows Note Clip removes the reliance on wire that brands documents with rust stains and that also ignites security alarms systems at airports and government buildings. There is no reliance on metal buckles, clamps, clips, and fasteners to hold the note papers. And equally as important is that the Windows Note Clip can be carried in a 3-ring school binder (10 inches by 12″ used by research students) or in a 3-ring conference notebook (65″×9″ used by research writers and business executives).

### BRIEF SUMMARY OF THE INVENTION

The Windows Note Clip is a note paper paperclip fabricated from thick cardstock paper (or from plastic as thin as a credit card) whose open diagonal windows clip (hold) and within the same function carry the note papers (or index cards). In addition to the special aspect of being fabricated from paper to be a paperclip, the extra benefit of the Windows Note Clip is that the paperclip carries the note papers while the paperclip is being carried in a 3-ring school binder or in a 3-ring conference notebook.

### BRIEF DESCRIPTION OF THE VIEWS OF THE DRAWING

The views of the Windows Note Clip are identified as FIG. 1 through FIG. 5.

FIG. 1 The front page view (the face) of the WINDOWS NOTE CLIP with 2 open diagonal windows.

FIG. 2 The draft view of the WINDOWS NOTE CLIP with 2 open diagonal windows for the 3 inch (″) by (×) 5″ note papers displays the border frame before cutting on the dash lines.

FIG. 3A view of the WINDOWS NOTE CLIP with the numbers and fractions in inches of the note frame and for the cuts on the dash lines of the tab frame and of the 2 diagonal windows to hold the smaller 3″×5″ note papers.

FIG. 4 The draft view of the WINDOWS NOTE CLIP with 2 open diagonal windows for the 4″×6″ note papers displays the border frame before cutting on the dash lines.

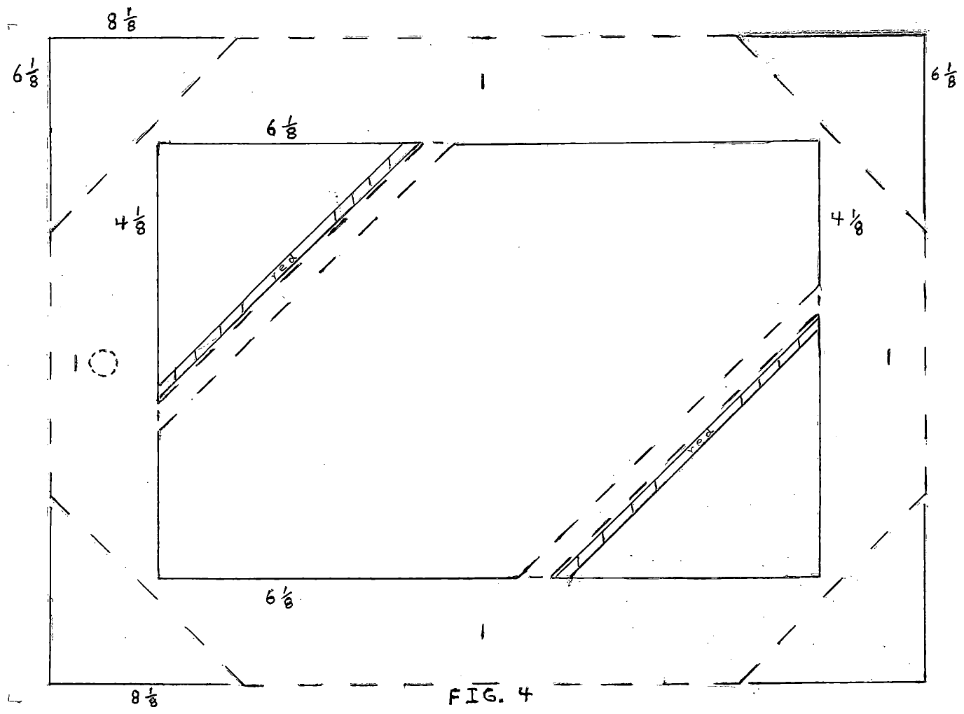

FIG. 5A view of the WINDOWS NOTE CLIP with the larger numbers and fractions in inches of the note frame and for the cuts on the dash lines of the tab frame and of the 2 diagonal windows to hold the standard 4″×6″ note papers.

### DETAILED DESCRIPTION OF THE INVENTION

inspiration 0014, identity 0016, features 0017, making 0023, using 0049, and reasons to patent 0058

Having a mind open to inspirations that translates words literally ignited the inquiry: Can paper be a paperclip? Can a page of paper hold note papers without being folded (an envelope), glued, pinned, rubber band, stapled, strung, taped, or wired? Can paper hug itself? The answer is found in mathematics.

From the oldest science named Mathematics is the combination (combo) of numbers & fractions in inches that reveal the framework of the Windows Note Clip. Although inspired by the metal slide buckle used in men's suspenders, the windows are diagonal, separated, and opposite to each other.

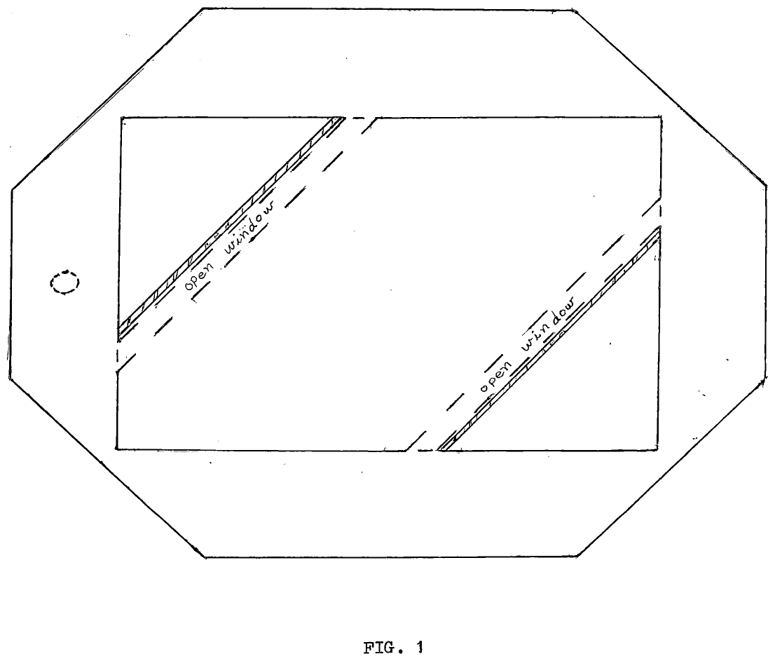

The identity of the Windows Note Clip is its 2 cut out, diagonal windows that become a note clip (a paperclip) intended for note papers (or index cards that are sold in the standard size of 4 inches by 6″ and in the smaller size of 3″×5″) as shown in FIG. 1.

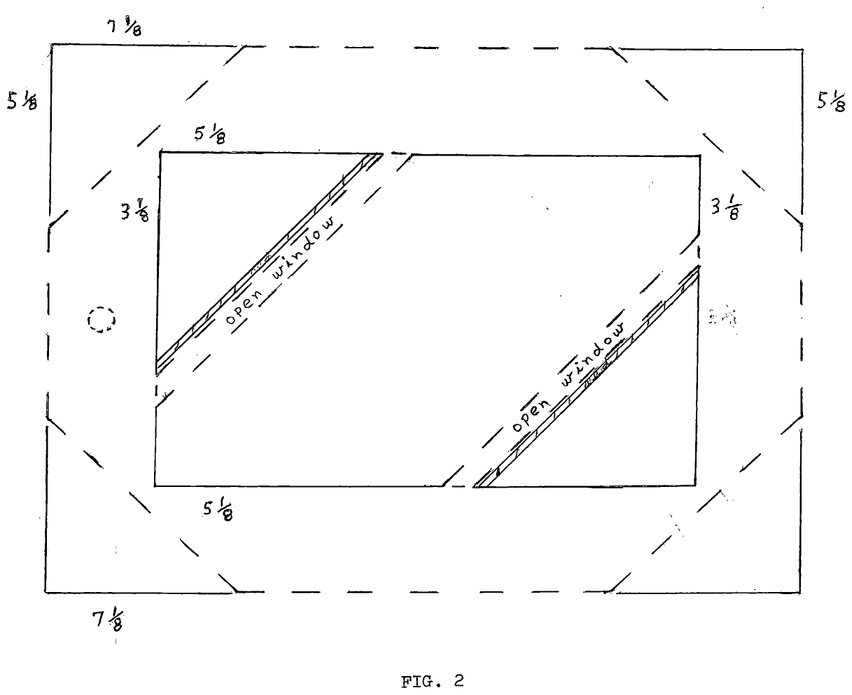

An important feature of the Windows Note Clip is the balance between the grasp (the tight hold) and the straight level of the note paper (outlined in FIG. 2) that depends on
1) the width within the open (cut out) diagonal window (how wide is the end or the “foot”) and on
2) the matching length of the 2 diagonal windows that touch the enlarged (by 1/16 inch) frame (the blue line) on all sides of the note paper (or the index card). Thus, the sides (left & right and top & bottom) of the frame are enlarged horizontally and vertically by a total of ⅛ of an inch to the size of the note paper as shown in FIG. 2.

That mathematical combo of the width at the end (the 7 foot) of the window (¼ inch) and the wide length of the diagonal open window [that connect to the enlarged frame (by 1/16 of an inch on all sides)) of the note paper (shown as a blue frame)] creates the hold (the grip, a tension) on the note paper, as well as keeps the note paper on a level straight line.

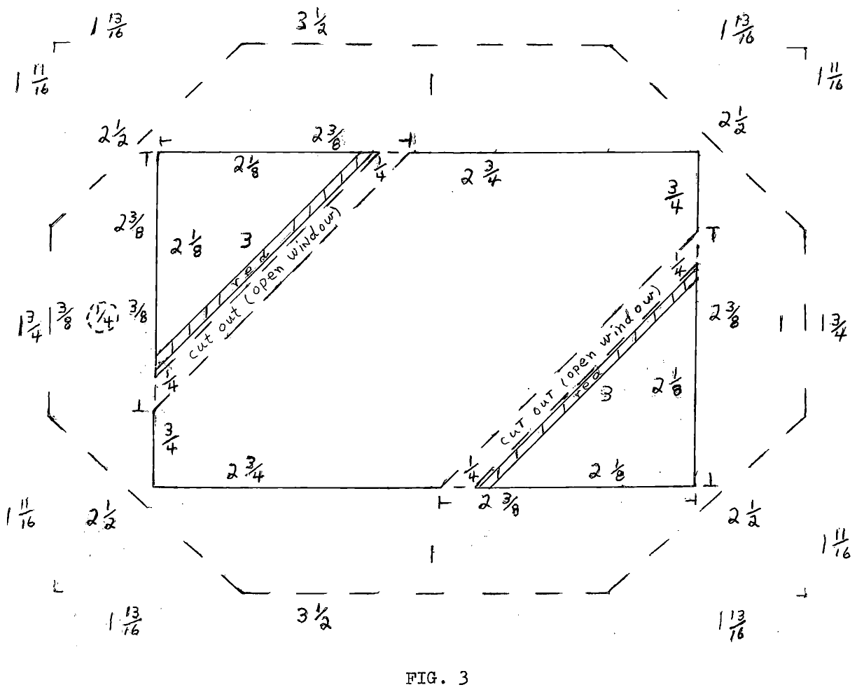

The combo of the foot with the length of the diagonal window uses the same 1/44 inch edge of the blue frame for the 2 opposite open windows to provide both the tension (the hold) and the level line for the note paper that is shown in FIG. 3. This is the discovery and the essence of the WINDOWS NOTE CLIP.

In the explanations about paperclips by other inventors is the consensus that a standard paperclip holds ¼ inches of a stack of papers. The proof that the Windows Note Clip follows that standard is that the open edge (the foot) of the windows is ¼ inches (as shown in FIG. 3), and the proof is also in the note papers.

Typing paper is 20 lb. (pounds) bond paper. Note paper [also known as (aka), scratch paper] is 16 lb (that is popular with students at ½ the cost of index cards). A light weight (lt. wt.) index card is 40 lb. Notice that the lt. wt. index card is double the weight of the standard typing paper. Thus, 2 note papers is within the weight of 1 lt. wt. index card. The standard college index card is 80 lb.

With the weights of the note paper and the lt. wt. index card stated (1 lt. wt. index card contains the weight of 2 note papers), let's review the paper in inches. The width of a window at 1/16 inch holds 4 note papers (or 2 lt. wt. index cards). Thus, a window ¼ inch wide holds 16 note papers (or 8 lt. wt. index cards).

Making (fabricating) the Windows Note Clip can arise from 2 materials: 1) cardstock (stiff paper) or 2) plastic. Cardstock is suited for a research student whose classes are 4 short months. The weight (wt.) of 130 pounds (lb.) is the heaviest cardstock (used for cereal boxes). Another option is to recycle the meal boxes of frozen meal trays that have a clean white interior (as well as a high glass foto of various meals on the back to represent a “food for thought”).

The clear plastic (as flexible as a credit card) is most suited for the research writer who has the need for durability (to last for years) in a paperclip. The name of the naturally clear plastic is polypropylene (PP, C3H6) which is a structural plastic. PP (a non-toxic; does not contain BPA) is a polymer resin mostly used as a cooked food's container. The lids of the plastic food containers (available in various sizes) may @ easily be recycled into a Windows Note Clip.

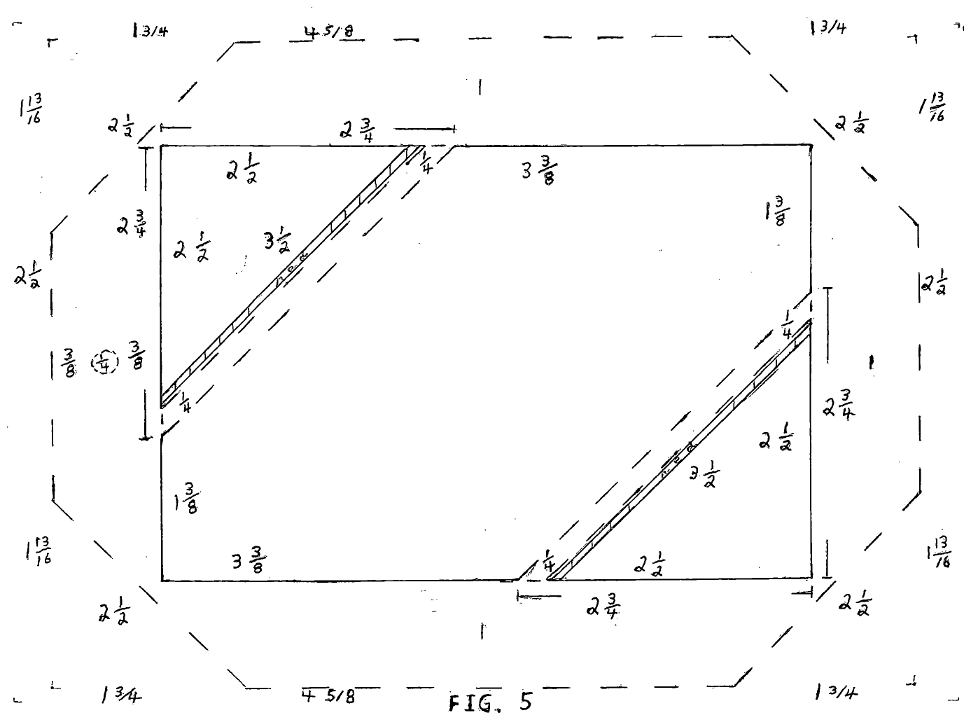

The drawing (FIG. 1) of the WINDOWS NOTE CLIP appears the same for the 2 sizes. The only difference is in the inches of the length of the lines drawn for the standard 4 inches (″) by (×) 6″ (FIG. 5) and for the smaller 3″×5″ (FIG. 3) note paper (or lt. wt. index card). Because the 3″×5″ is the more popular note paper (being half the cost of index cards) among the research students (who outnumber the research writer by 1,000 to 1), the inches of the smaller Windows Note Clip are employed in this How To Make explanation.

Draw with a pencil an oblong box that is 7⅛ inches wide and 5⅛ ″ tall. This is the border frame (FIG. 2) on the cardstock.

Draw with a blue ink pen an oblong box that is 1 inch within the border frame (on all sides). That blue oblong box inside the border frame is 5⅛″ wide and 3⅛″ tall is the note frame (FIG. 2). The secret mathematical code for the note frame is that the blue note frame is an extra 1/16 of an inch around the 4 sides of the small 3″×5″ note paper and of the standard 4″×6″ note paper (or index card).

The oblong blue frame (in FIG. 3) comprises the essential measurements (the skeleton) of the Windows Note Clip that holds onto the note paper through the tension provided by the opposite open diagonal windows upon the note paper.

From the upper left corner of the blue note frame, mark an ink period 2⅛ inches on the lines (top & left) of that blue left right angle. Draw diagonal dash lines (¼″ line followed by a ¼″ space) shown in FIG. 3 between the periods of the upper blue left corner (top & left lines).

From the same upper left corner, place a second period 2⅜ inches on the lines (top & left) of the right angle (FIG. 3). Draw diagonal dashes between the 2nd periods. These dashes outline the open window shown in FIG. 3.

Repeat the 2 sets of periods and the 2 sets of dashes for the lower right corner of the note frame to display the 2nd open window shown in FIG. 3.

Now establish the exterior shape in ink of the border frame (that is 1″ away from the blue note frame). From the upper left corner of the pencil border frame, mark an ink period 1 13/16 inches on the top pencil line and mark an ink period 1 11/16 inches down on the left adjacent pencil line. Draw in ink the diagonal dash lines (¼″ dash followed by a ¼″ space) between the periods as shown in FIG. 3.

Repeat the marked periods and the diagonal dashes on the remaining 3 corners (top right, bottom left, & bottom right).

Having established the exterior diagonal dashes for the border frame, mark in ink the sides with dashes between the 2 marked points of each of the 4 sides. The dashes of the corners and the sides are the exterior body (aka, an octagonal rectangle) of the WINDOWS NOTE CLIP (FIG. 33).

A punch hole is on the left center of the border frame (FIG. 3). Draw in ink a ¼ inch dash circle ⅜ inches from the left edge of the border frame and ⅜ inches left of the note frame as shown in FIG. 3. The center of the circle aligns with the half distance of 1 9/16 inches on the left side of the note frame.

Draw a red ink line next to the diagonal dash line of the open window that is closest to the corner of the blue frame represented as a shaded line in FIG. 3. The base of the left top isosceles right triangle, as well as the base of the bottom right right triangle (not the diagonal dash lines in the middle of the blue note frame) is inked with a 1/16 inch red line that locates the open diagonal window. Those 2 opposite diagonal red lines become the visible lips of the open diagonal windows that hold the note papers. The red base line, the white paper (or clear plastic), and the blue note frame (of the enlarged note paper) display the colors of the United States Flag to denote that the invention was created and Made in America.

The entire process of making the WINDOWS NOTE CLIP is through cuts. Always cut on the outside of the dash line to retain the full-body measurement of the paperclip. Use a X-Acto knife (a razor sharp blade). A sharp paring knife provides a larger handle to hold for more control of the cutting. Do NOT rely on the strength of the hand for the pressure on the knife. That pressure cannot be measured. Use a small hammer (a metal meat tenderizer hammer) to tap out (measured number) the cut. A sharp utility scissors neatly trims the cut (if required).

The 1st cut is the ¼ inch dash line on left edge (the foot) of the blue note frame at the top left corner between the 2⅛ inch period and the 2⅜ inch period (FIG. 3). Because the left side is a more difficult reach, that cut is the first.

This short ¼ inch edge on the 4 sides of the blue note frame is known as the foot of the diagonal window. The surface space of the paper will provide the required taut support for an accurate cut. Because the ¼ inch foot requires that support, the foot is the first cut. Remember to always have the cutting blade pointing to the center of the cut. That position prevents cutting beyond the marked period, as well as avoids initiating a tear.

When the blade cuts to the midpoint (⅛ inch), turn the knife around onto the other end point. Tap the knife so that the blade cuts forward to the middle once again.

Repeat the ¼ inch cut for the right top foot of the diagonal window in the top left corner of the blue note frame.

Repeat the above ¼ inch cut on the left foot and the right foot of the bottom diagonal window of the lower right corner of the blue note frame.

The 5th cut (after the 4 foot cuts) is the top left diagonal line of the top left window (FIG. 3). To get a strong bite of the cardstock (or plastic), slowly tap the knife blade down at the 2⅛ inch period on the top diagonal dash line of the window. Slowly saw the blade to the middle. Then turn the blade around (to face the top) onto the 2⅛ inch period on the left side of the top diagonal dash line. Saw the blade to the middle.

Repeat the cutting (the 6th cut) on the lower diagonal of the top left window.

Repeat the cutting on the top (the 7th cut) and on the lower (the 8th cut) diagonal dash line of the bottom right window.

The 9th cut (after the 4 diagonal cuts to open the windows inside the blue note frame) is the cut (cut on the outside of the dash line) around the 4 sides of the border (exterior) frame (FIG. 3). The utility scissors cut that good.

The 13th cut (after the 4 sides of the 1″ border frame) with the utility scissors is the exterior, diagonal dash line of the top left corner of the border frame. The 14th cut is on the exterior, diagonal dash line of the top right corner of the border frame. The aftermath of the 13th & 14th cut is a top, center border tab that is 331/2 inches wide (as shown in FIG. 3).

Repeat the cut of the exterior, diagonal dash line on the bottom left corner and on the bottom right corner of the border frame. The aftermath of the 15th & 16th cut is a left side and a right side border tab that is 1¾ inches tall. Another aftermath is a 3½ inches wide center border tab (as shown in FIG. 3). After the corners are diagonally cut off, the 1 inch wide border frame, the result is a border tab frame (aka, an octagonal rectangle) that fingers hold to use the Windows Note Clip.

The final cut (the 17th) is easily made with a hole puncher. Punch out a ¼ inch hole in the middle of the left border tab . . . . The circle is ⅜ inches away from the edge of the left border tab and is also ⅜ inches from the left side of the blue note frame. With all 17 cuts completed, the WINDOWS NOTE CLIP (as shown in FIG. 1) is ready to hug note papers (or index cards).

The Windows Note Clip made from cardstock meets the short-term needs of a research student collecting facts for a school report. The ¼ inch width (the depth) of the diagonal open windows can hold as many as 16 note papers (or 8 lt. wt. index cards that are twice as thick as note papers).

After a research student collects 7 facts on 7 note papers, they are ready for the Windows Note Clip. Start the inserts in reverse page order so that page 1 is on top. First, insert the bottom right corners of pages 4, 5, 6, & 7 under the red lip of the bottom right open window. And 2nd, insert the top 7 left corners of the note papers under the red lip of the top left open window. Repeat the insert as the 2nd group for pages 1, 2, & 3.

To remove the note papers from the Windows Note Clip, have the fingers of the left hand press up against the back middle (to form a small hill) of the paper paperclip. Then, gently pull the top corners of the first 4 note papers out of the red lip of the top left open window. Repeat the pull for the last 3 note pages 5, 6, & 7 as a 2nd withdrawal.

Another use of the paper paperclip includes the 4 exterior diagonal edges between the border tabs. Those slanted edges allow the fingers a closer closed contact to the open windows, as well as a more comfortable fit in the palm of the hand for a better hold of the Windows Note Clip.

The hole between the diagonal edges on the left (the down-slant shoulders) allows the Windows Note Clip to hang on the middle ring of the 3-ring binder (10 inch by 12″ school binder, and the 6″×9″ conference notebook) in the space between the middle ring and the 2 exterior rings.

The diagonal edges on the right offer a distinct visibility of the Windows Note Clip. It rests in the 3-ring binder beneath the 8½″×11″ or the 5¾″×8¼″ lined white paper.

An alliteration (c) is employed to spotlight this use. A Windows Note Clip in addition to functioning as a clip (a hold) also provides the service to carry (to transport) the note papers (or index cards).

During the trip to the library, the Windows Note Clip performs the extra service as a pseudo-backpack by toting blank note papers for future annotations.

The hole also accommodates the Windows Note Clip to hang on a pin pressed into a bulletin board or on a small screw drilled into the side of a desk. A desk in a study room or a home office also allows a plastic double-wall napkin holder to hold the Windows Note Clip in a horizontal standing position.

The windows Note Clip is a distinctive invention for its reliance on paper (130 lb. cardstock) to hold the note papers. The paper paperclip does not rely on wire, a staple, a pin, a spring, string, a metal clamp (not a clipboard), a metal clasp (not a fastner), glue, tape, or folds (not an envelope).

Because the Windows Note Clip is fabricated with cardstock (or plastic), the paperclip avoids branding documents with rust (a common stain from metal clips). The absence of metal also avoids setting off security scanners at airports and buildings.

For a longer time of use by research writers, plastic is a good substitute to the cardstock.

The main reason to patent this office tool in addition to being fabricated with cardstock (or plastic) is that the Windows Note Clip is a mathematical interplay of the width within the open windows and the width between the 2 open windows. That mathematical combo creates a clip (a hold) on the note papers. And that hold is called a paperclip.

Within the same function as a clip, using the same mathematical combo, the Windows Note Clip carries the note papers (or index cards) without the contact of human fingers. Thus, thevdouble diagonal open windows provide the simultaneous service of clip and carry. This 2nd improvement to carry the note papers occurs by the hold of the 2 open diagonal window frames to subtly function as unseen satchel straps.

1. Two open diagonal windows opposite to each other on cardstock (or plastic) are the frameworks of the Windows Note Clip that offers two simultaneous functions of clip (holding) and carry (transporting) the note papers (or index cards).
